(19) United States
(12) Patent Application Publication
(10) Pub. No.: US 2015/0106733 A1
(43) Pub. Date: Apr. 16, 2015

(54) TERMINAL DEVICE, THIN CLIENT SYSTEM, DISPLAY METHOD, AND RECORDING MEDIUM

(71) Applicant: FUJITSU LIMITED, Kawasaki-shi (JP)

(72) Inventor: Kazuki Matsui, Kawasaki (JP)

(21) Appl. No.: 14/466,596

(22) Filed: Aug. 22, 2014

(30) Foreign Application Priority Data
Oct. 10, 2013 (JP) 2013-213110

(51) Int. Cl. H04L 29/08; G06F 3/0481

(52) U.S. Cl. CPC H04L 67/10; G06F 3/0481
USPC 715/744

(57) ABSTRACT

A terminal device includes: a memory; and a processor coupled to the memory. The processor executes a process including: receiving a screen image from a server device connected via a network; storing the screen image received; displaying the screen image stored in a storage; first computing a switching end time based on an amount of one screenful of screen image data that is determined from a screen size of a display and an available band for communications with the server device; second computing a switching start time based on a switching time of the screen image obtained from the screen size and a switching speed of the screen image, and the switching end time; and reading the screen image from the storage and displaying the screen image on the display at the switching speed after the switching start time has elapsed from reception of a user's switching operation.

### CROSS-REFERENCE TO RELATED APPLICATION

This application is based upon and claims the benefit of priority of the prior Japanese Patent Application No. 2013-213110, filed on Oct. 10, 2013, the entire contents of which are incorporated herein by reference.

### FIELD

The embodiment discussed herein is related to a terminal device, a thin client system, a display method, and recording medium.

### BACKGROUND

Systems referred to as a thin client are known. The thin client system is constructed to provide a client terminal only with a minimum possible function and allow the server to manage resources such as applications and files.

Such a thin client system behaves as if the client terminal itself executes processing or holds data even though the result of processing executed by the server or the data held by the server is actually displayed on the client terminal.

When screen data to be displayed on the client terminal is transmitted between the server and the client terminal as described above, screen updates occur along with operations. When a screen update occurs in the thin client system, the server transmits, to the client terminal, differential screen data between before and after the screen update. Here, for example, when a slide show or a performance such as scroll display for screen switching is conducted in a presentation or the like, updates occur on many parts of the screen, and the differential screen data is transmitted to the client terminal.

Patent Document 1: Japanese Laid-open Patent Publication No. 7-111544

Patent Document 2: Japanese Laid-open Patent Publication No. 2008-46803

However, the aforementioned technique may cause a delay in the screen switching due to a delay in transmission.

For example, when the client terminal is connected to the server in a mobile communication environment, a performance such as scroll display for switching between slides may cause a great deal of differential screen data to be transmitted to the client terminal. In a network between the server and the client terminal, this in turn may cause the amount of transfer to be restricted by a varying available band, leading to a delay in transmission. As a result, since the client terminal may receive and display the differential screen data at unstable speed, the speed may be lower than the screen switching speed by scroll display or the like, so that the screen switching such as scroll display may be performed intermittently with smoothness impaired.

### SUMMARY

According to an aspect of the embodiments, a terminal device includes: a memory; and a processor coupled to the memory. The processor executes a process including: receiving a screen image from a server device connected via a network; storing the screen image received; displaying the screen image stored in a storage; first computing a switching end time, in which switching of the screen image is ended, based on an amount of one screenful of screen image data that is determined from a screen size of a display and an available band for communications with the server device; second computing a switching start time, in which switching of the screen image is started, based on a switching time of the screen image obtained from the screen size and a switching speed of the screen image, and the switching end time; and reading the screen image from the storage and displaying the screen image on the display at the switching speed after the switching start time has elapsed from reception of a user's switching operation.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a configuration of a thin client system of an embodiment;

FIG. 2 is an explanatory view illustrating an example of switching between display images;

FIG. 3 is an explanatory view illustrating an example of the relation between the reception time and the switching time;

FIG. 4 is a sequence diagram illustrating an example of the operation of a thin client system of an embodiment;

FIG. 5 is an explanatory view illustrating another example of switching between display images;

FIG. 6 is an explanatory view illustrating another example of the relation between the reception time and the switching time; and

FIG. 7 is an explanatory view illustrating an example of a computer for executing a display program.

### DESCRIPTION OF EMBODIMENTS

Preferred embodiments will be explained with reference to accompanying drawings. Note that these embodiments will not limit the disclosed techniques. Furthermore, the following embodiments may also be combined, as appropriate, without causing inconsistency.

System Configuration

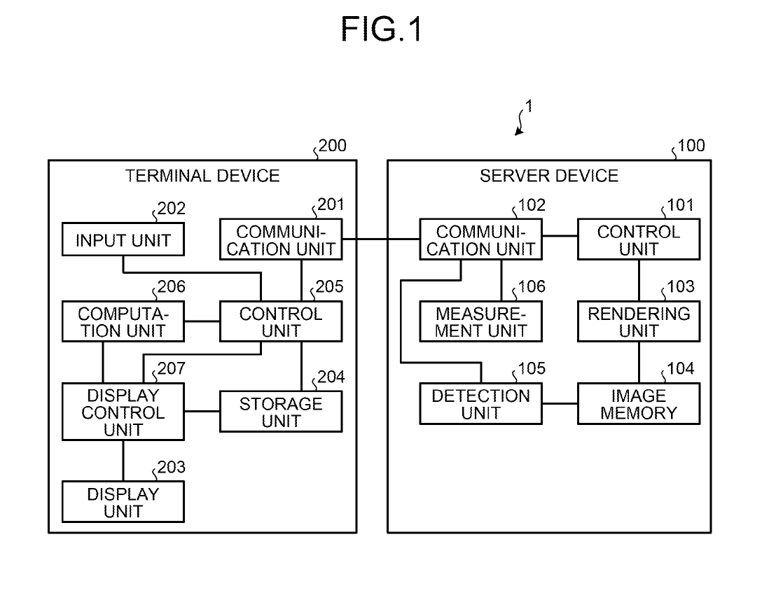

First, a description will be made to the configuration of a thin client system according to this embodiment. FIG. 1 is a block diagram illustrating an example of the configuration of the thin client system of this embodiment. The thin client system 1 illustrated in FIG. 1 allows a server device 100 to provide remote control to the display screen of a terminal device 200. That is, the thin client system 1 behaves as if the terminal device 200 itself executes processing or holds data while in practice, allowing the terminal device 200 to display the result of processing executed or data held by the server device 100.

The thin client system 1 illustrated in FIG. 1 has the server device 100 and the terminal device 200. Note that the example of FIG. 1 illustrates the case where one terminal device 200 is connected to one server device 100; however, any number of client terminals may also be connected thereto.

These server device 100 and terminal device 200 are connected communicably to each other over a predetermined network. Such networks, wired or wireless, as can be employed herein may include any types of communication networks such as the Internet, a Local Area Network (LAN), or a Virtual Private Network (VPN). Note that by way of example, such a case is assumed where the communication protocol to be employed between the server device 100 and the terminal device 200 is the Remote Frame Buffer (RFB) protocol in the Virtual Network Computing (VNC).

The server device 100 is an example of information processing apparatus and is configured by a computer which provides remote control service to a screen displayed by the terminal device 200. The server device 100 has a remote screen control application for the server, which is installed or preinstalled. Note that hereinafter, the remote screen control application for the server may also be referred to as the “server-side remote screen control app.”

This server-side remote screen control app functions to provide the remote screen control service as a basic function. In one aspect, the server-side remote screen control app acquires operation information on the terminal device 200 and then allows an application operating on the server to execute the processing requested by the operation. Then, the server-side remote screen control app creates a screen for displaying the result of processing executed by the application and then transmits the resulting screen to the terminal device 200. At this time, the server-side remote screen control app transmits a rectangular update image, that is, a region with a collection of pixels of changes made from a bit map image that was displayed on the terminal device 200 before the current screen was created. Note that the image of an update is not limited to a rectangular image but may have any shape other than the rectangular one.

In addition, the server-side remote screen control app also functions to compress data of a significant move between frames into video oriented compression scheme data and then transmit the resulting data to the terminal device 200. In one aspect, the server-side remote screen control app divides a screen created from the result of processing executed by an application into a plurality of regions, and then monitors the frequency of changes in each divided region. At this time, the server-side remote screen control app transmits, to the terminal device 200, the attribute information of a region of which frequency of changes has exceeded a threshold value, that is, a high-frequency change region. In addition, the server-side remote screen control app encodes a bit map image of a high-frequency change region to data according to Moving Picture Experts Group (MPEG) scheme such as MPEG-2 or MPEG-4 and then transmits the resulting data to the terminal device 200. Note that the example here illustrates the case where data is compressed into data according to the MPEG scheme; however, the invention is not limited thereto. For example, any compression encoding scheme such as the Motion-JPEG (Joint Photographic Experts Group) scheme can be employed so long as the scheme is a video oriented compression scheme.

The server device 100 measures, in a network between the server device 100 and the terminal device 200, an available band that can be employed, and then transmits the resulting available band to the terminal device 200. For example, the server device 100 acquires, from the terminal device 200, a transfer time for image data that has been just transmitted to the terminal device 200. For example, the server device 100 measures an available band based on the amount of data of the image data having been just transmitted, the transmission time which the server device 100 transmitted, and the transfer time acquired from the terminal device 200. The server device 100 transmits the measured available band to the terminal device 200.

The terminal device 200 is a computer which is provided with remote screen control service by the server device 100. By way of example, such terminal devices 200 to be employed may include a tablet terminal, a smartphone, a portable personal computer, and the like. Furthermore, other examples of the terminal device 200 to be employed may also include fixed terminals such as stationary personal computers in addition to mobile terminals such as cellular telephones, Personal Handyphone Systems (PHS), or Personal Digital Assistants (PDA). The terminal device 200 may have a client oriented remote screen control application installed or preinstalled. Note that hereinafter, the client oriented remote screen control application may also be referred to as the “client-side remote screen control app.”

This client-side remote screen control app functions to notify the server device 100 of operation information that has been received via various types of input devices such as a touch panel, a mouse, or a keyboard. In one aspect, the client-side remote screen control app notifies, as the operation information, the degree of operation such as tap or flick on a touch panel integrated with a display unit. As other examples, the client-side remote screen control app notifies the operation information such as the right and left clicks of the mouse as well as a double click or drag, or the amount of movement of the mouse cursor that is acquired through a move operation of the mouse. As still other examples, the client-side remote screen control app also notifies the operation information such as the amount of rotation of the mouse wheel or the type of a key on the keyboard that has been depressed.

Furthermore, the client-side remote screen control app functions to display an image received from the server device 100 on a predetermined display unit. In one aspect, when having received a rectangular update bit map image from the server device 100, the client-side remote screen control app displays the rectangular update image at the position at which the previous bit map image has been changed. In another aspect, when having received the attribute information of a high-frequency change region from the server device 100, the client-side remote screen control app employs a region of the display screen, the region being associated with the position included in the attribute information, as a blank region of the bit map image in which nothing is to be displayed. Then, when having received video oriented compression scheme data, the client-side remote screen control app decodes the data and then displays the resulting data in the blank region.

Furthermore, when a presentation or the like is performed using an application executed on the server device 100, the terminal device 200 may conduct a performance such as scroll display to slide screens, that is, to switch between screens. The terminal device 200 temporarily saves, i.e., buffers, on a storage unit, the image data of the next slide which has started to be received, and then starts the scroll display of the temporarily saved next slide image so that the completion of the reception takes place at the same time as the end of the scroll display.

Configuration of Server Device

Now, a description will be made to the functional structure of the server device 100 according to this embodiment. As illustrated in FIG. 1, the server device 100 includes a control unit 101, a communication unit 102, a rendering unit 103, an image memory 104, a detection unit 105, and a measurement unit 106. Note that the example of FIG. 1 may also include, other than those function units illustrated in FIG. 1, various types of function units which are included in known computers, for example, functions such as various types of input devices or display devices.

The control unit 101 controls the entire server device 100, and executes the server-side remote screen control app and various types of applications. Furthermore, the control unit 101 allows the server-side remote screen control app to control the rendering unit 103, the image memory 104, and the detection unit 105 so as to provide the remote screen control service. The control unit 101 executes various types of applications, for example, a presentation application. Upon reception of operation information from the communication unit 102, the control unit 101 executes the server-side remote screen control app and various types of applications depending on the operation information.

The communication unit 102 is implemented, for example, by a Network Interface Card (NIC). The communication unit 102 is a communication interface which is connected by wire or by radio to the terminal device 200 over a network and serves to communicate information to and from the terminal device 200. When the terminal device 200 is connected to the Internet, the communication unit 102 can be connected to the terminal device 200, for example, via a VPN constructed on the Internet as a network. The communication unit 102 receives operation information from the terminal device 200 for output to the control unit 101. Furthermore, when image data is entered from the detection unit 105, the communication unit 102 transmits the image data to the terminal device 200. Furthermore, when an available band is entered from the measurement unit 106, the communication unit 102 transmits the available band to the terminal device 200.

The rendering unit 103 is controlled by the server-side remote screen control app executed in the control unit 101. The rendering unit 103 renders an image from an application executed on the control unit 101 and stores the image in the image memory 104. That is, the rendering unit 103 renders a display image (screen image) to be displayed on the terminal device 200 and stores the display image in the image memory 104.

The image memory 104 or a so-called frame buffer is a storage device for storing a bit map image or an image corresponding to the entire page rendered by the rendering unit 103. In one aspect, such an image memory 104 may be a semiconductor memory element such as a Random Access Memory (RAM) including a Video Random Access Memory (VRAM), a Read Only Memory (ROM), or a flash memory. Note that it is also acceptable to employ, as the image memory 104, storage devices such as the hard disk or the optical disk.

The detection unit 105 is controlled by the server-side remote screen control app executed by the control unit 101. The detection unit 105 detects, if any, an update of an image rendered on the image memory 104, and captures the update and produces the differential image data. The detection unit 105 compresses the produced differential image data. The detection unit 105 employs, as a compression codec, for example, JPEG for still images and MPEG-2 or MPEG-4 for moving images. The detection unit 105 outputs compressed differential image data to the communication unit 102.

The measurement unit 106 measures communications at the communication unit 102. For example, the measurement unit 106 measures the amount of communication data between the communication unit 102 and a communication unit 201 of the terminal device 200, to be discussed later, every one second, and measures an available band or a band that is available between the communication unit 102 and the communication unit 201. Furthermore, for example, concerning image data having been just transmitted to the terminal device 200, the measurement unit 106 acquires the amount of the image data from the communication unit 102. Furthermore, for example, concerning image data having been just transmitted to the terminal device 200, the measurement unit 106 acquires the transfer time via the communication unit 102 from the terminal device 200. For example, the measurement unit 106 measures an available band based on the amount of image data having been just transmitted, the transmission time which the communication unit 102 transmitted, and the transfer time acquired from the terminal device 200. The measurement unit 106 outputs the resulting available band to the communication unit 102.

Configuration of Terminal Device

Now, a description will be made to the functional structure of the terminal device 200 according to this embodiment. As illustrated in FIG. 1, the terminal device 200 includes the communication unit 201, an input unit 202, a display unit 203, a storage unit 204, a control unit 205, a computation unit 206, and a display control unit 207. Note that the example of FIG. 1 may also include, other than those function units illustrated in FIG. 1, various types of function units which are included in known computers.

The communication unit 201 is implemented by a wireless communication module which accommodates, for example, a cellular telephone line, a wireless Local Area Network (LAN), Bluetooth (registered trade mark), and the Near Field Communication (NFC). For example, the communication unit 201 is a communication interface which is connected to the Internet over a wireless base station and constructs a VPN between the communication unit 201 and the server device 100 connected to the Internet so as to communicate information therebetween. Note that the communication unit 201 may also be implemented, for example, by a NIC so as to be connected to the server device 100 by wire or by radio over a network. Note that the communication unit 201 may employ, as a cellular telephone line, for example, the third generation (3G) mobile communication system, the Worldwide Interoperability for Microwave Access (WiMAX) communication system, and the Long Term Evolution (LTE) communication system.

The communication unit 201 receives image data and an available band from the server device 100 for output to the control unit 205. Furthermore, when operation information is entered from the control unit 205, the communication unit 201 transmits the operation information to the server device 100.

The input unit 202 is an input device for receiving various types of operations from the user. For example, the input unit 202 is implemented by a touch panel, a mouse, or a keyboard. Furthermore, when the touch panel is employed, the input unit 202 is integrated with the display unit 203 which serves as a display device. The input unit 202 outputs operation information depending on a user's operation to the control unit 205.

The display unit 203 is a display device for displaying various types of information and implemented, for example, by a liquid crystal display. Furthermore, when the input unit 202 to be used is a touch panel, the display unit 203 is integrated with the input unit 202. When image data is entered from the display control unit 207, the display unit 203 displays a screen corresponding to the image data. Furthermore, in the terminal device 200, the display unit 203 is implemented, for example, by a projector. For example, when the display unit 203 to be employed is a projector, the same presentation screen can be displayed, for example, on the display unit 203 of a tablet terminal at user's hand and the projector which is separated from the tablet terminal but functionally serves as the display unit 203.

The storage unit 204 stores the image data received by the communication unit 201 via the control unit 205. The storage unit 204 temporarily saves, that is, buffers the image data to be displayed on the display unit 203, and the temporarily saved image data is read by the display control unit 207. In one aspect, the storage unit 204 may be a semiconductor memory element such as the RAM including the VRAM, the ROM, and the flash memory. Note that the storage unit 204 to be employed may also be a storage device such as a hard disk or an optical disc. Furthermore, the storage unit 204 stores an alternative image to be temporarily displayed when a switching start time Ts is greater than a predetermined value.

The control unit 205 controls the entire terminal device 200 and executes the client-side remote screen control app. When image data and an available band are entered from the communication unit 201, the control unit 205 stores the image data in the storage unit 204, and outputs the available band to the computation unit 206. Furthermore, when operation information is entered from the input unit 202, the control unit 205 outputs the operation information to the communication unit 201 and sets the current time to an operation start time T0 for output to the display control unit 207. Furthermore, when display information is directly entered from the computation unit 206, the control unit 205 outputs the image data entered from the communication unit 201 to the display control unit 207 without storing the image data in the storage unit 204. Note that the control unit 205 decompresses the image data which has been compressed when being stored in the storage unit 204 or outputted to the display control unit 207. Furthermore, the control unit 205 may also store the image data in the storage unit 204 when no display information is directly entered even after a predetermined time elapsed from the entry of the operation information. Note that the predetermined time can be set to, for example, 100 msec, but may also be changed, as appropriate, depending on the computation speed of the computation unit 206.

The computation unit 206 receives the screen size of the display unit 203 from the display control unit 207. Furthermore, in the computation unit 206, the switching speed of a display image, that is, a screen image to be displayed on the display unit 203 is set by the user or the administrator of the system, for example, on the server device 100 via the input unit 202 or the communication unit 201. That is, the computation unit 206 is provided with the setting of a predetermined switching speed as the switching speed at which the display image is switched. Note that the setting of the switching speed can be changed in the same manner as at the time of setting. The computation unit 206 includes a first computation unit for computing a switching end time and a second computation unit for computing a switching start time.

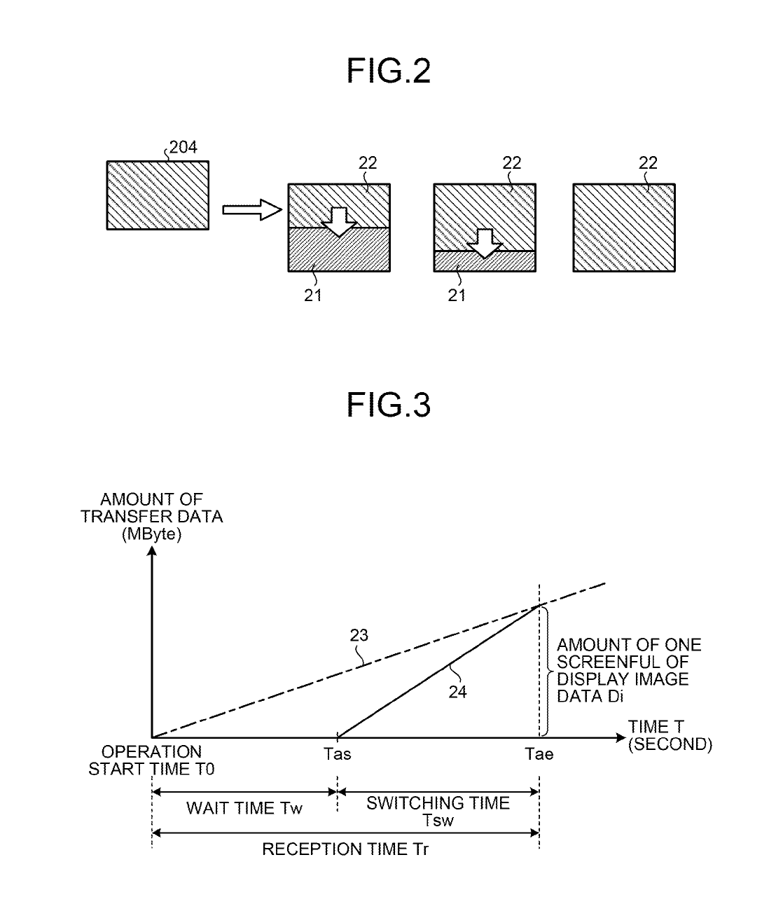

The computation unit 206 computes a switching time Tsw of a display image based on the screen size of the display unit 203 and the predetermined switching speed of display images. Here, referring to FIG. 2, a description will be made to the switching of display images. FIG. 2 is an explanatory view illustrating an example of the switching of display images. The example of FIG. 2 illustrates the case where, for example, a next slide 22 is scroll displayed from top to bottom of the screen as the switching of display images. The image data of the next slide 22 temporarily saved in the storage unit 204 is scroll displayed at the switching speed, for example, a constant scroll speed Vs from top to bottom on a current slide 21. The switching time Tsw of a display image is 780/500=1.56 seconds, where for example, the screen has a horizontal size of 1280 pixels and a vertical size of 780 pixels, and a scroll speed Vs of 500 pixels/second.

Furthermore, the computation unit 206 computes the amount of one screenful of display image data, that is, the amount of data of the next slide 22 to be scroll displayed based on the screen size of the display unit 203 and an average compression ratio. For example, assuming that the screen has a horizontal size of 1280 pixels and a vertical size of 780 pixels, the computation unit 206 computes the amount of color (RGB) bit map image data as 1280×780×3=2.85 MBytes. For example, assuming that an average compression ratio is, for example, 1/10 to obtain a JPEG image, or a compressed image, the computation unit 206 computes the amount of one screenful of display image data to be 293 KBytes. The computation unit 206 temporarily computes the amount of one screenful of display image data at the time of initial setting, and subsequently employs the value computed at the time of initial setting so long as the screen size of the display unit 203 is not changed.

Furthermore, the computation unit 206 receives an available band from the control unit 205. The computation unit 206 computes the switching end time Te, in which the switching of display images is ended, based on the computed amount of one screenful of display image data and the available band. That is, the computation unit 206 computes the time, in which the display image is completely displayed, when the received image data is directly displayed on the display unit 203 without buffering the image data. For example, the computation unit 206 computes the switching end time Te to be (293×1024×8)/(1×1024×1024)=2.29 seconds, where the amount of one screenful of display image data is 293 KBytes and the available band is 1 Mbps. Note that the switching end time Te has the difference of the transmit/receive time of operation information from a reception time Tr in which the image data of the next slide 22 is completely displayed while the image data is received and displayed from the user's operation start time T0. However, since the transmit/receive time is much shorter than the reception time Tr, it is assumed, for simplicity, in the descriptions below that the switching end time Te and the reception time Tr are the same.

Furthermore, the computation unit 206 computes the switching start time Ts, in which the switching of display images is started, based on the switching time Tsw and the switching end time Te. The computation unit 206 subtracts the switching time Tsw from the switching end time Te to compute the switching start time Ts. The computation unit 206 computes the switching start time Ts to be 2.29−1.56=0.73 seconds, where for example, the switching time Tsw is 1.56 seconds and the switching end time Te is 2.29 seconds. Note that the switching start time Ts has the difference of the transmit/receive time of operation information from a wait time Tw in which the image data of the next slide 22 is received and starts to be displayed from the user's operation start time T0. However, since the transmit/receive time is much shorter than the wait time Tw, it is assumed, for simplicity, in the descriptions below that the switching start time Ts and the wait time Tw are the same. The computation unit 206 outputs, to the display control unit 207, the switching start time Ts and the switching speed, which have been computed. Furthermore, when the switching start time Ts is less than a predetermined value, the computation unit 206 outputs display information directly to the control unit 205. Here, the predetermined value may be, for example, 50 msec.

Here, referring to FIG. 3, the relation between the reception time Tr and the switching time Tsw or the like will be described below. FIG. 3 is an explanatory view illustrating an example of the relation between the reception time and the switching time. As illustrated in FIG. 3, the terminal device 200 starts to receive the image data of the next slide 22 at the operation start time T0. Illustrated by a graph 23 is the amount of transfer data in the case where the received image data is directly displayed on the display unit 203 without buffering the image data. As illustrated by the graph 23, the terminal device 200 receives the next slide 22, that is, the amount of one screenful of display image data Di in the reception time Tr and completely displays the image data. In the case of the aforementioned example, the reception time Tr is the same as the switching end time Te, i.e., 2.29 seconds.

Illustrated by a graph 24 is the amount of transfer data that is needed when the image data of the next slide 22 is scroll displayed at the scroll speed Vs. The graph 24 is drawn in a manner such that the time in which the image data of the next slide 22 for the graph 23 is received and completely displayed coincides with the switching end time Tae that is obtained by adding the switching end time Te to the operation start time T0. In other words, the terminal device 200 starts the scroll display at the switching start time Tas that is obtained by adding the switching start time Is to the operation start time T0. That is, the terminal device 200 starts the scroll display at the time at which the graph 24 intersects the axis of time T after the wait time Tw has elapsed. As illustrated in the aforementioned example, the wait time Tw is the same as the switching start time Ts, i.e., 0.73 seconds. That is, the terminal device 200 starts the scroll display after 0.73 seconds have elapsed from the operation start time T0.

Referring back to the description of FIG. 1, the display control unit 207 receives the operation start time T0 from the control unit 205 and receives the switching start time Ts and the switching speed from the computation unit 206. The display control unit 207 adds the switching start time Ts to the operation start time T0 to compute the switching start time Tas. The display control unit 207 refers, for example, to the Real Time Clock (RTC) to determine whether the current time is after the switching start time Tas. When the current time is after the switching start time Tas, the display control unit 207 reads temporarily saved image data from the storage unit 204 and displays the image data on the display unit 203 at the switching speed. In the aforementioned example of scroll display, the display control unit 207 performs scroll display to switch the current slide 21 to the next slide 22 at the scroll speed Vs. Furthermore, the display control unit 207 detects the screen size of the display unit 203 for output to the computation unit 206.

Furthermore, when image data is entered from the control unit 205, the display control unit 207 determines that the image is to be directly displayed, and then displays the image data at the switching speed on the display unit 203 without temporarily saving the data in the storage unit 204. Note that the switching speed to be employed in this case is a preset switching speed as in the case of the computation unit 206.

Now, a description will be made to the operation of the thin client system 1 of this embodiment.

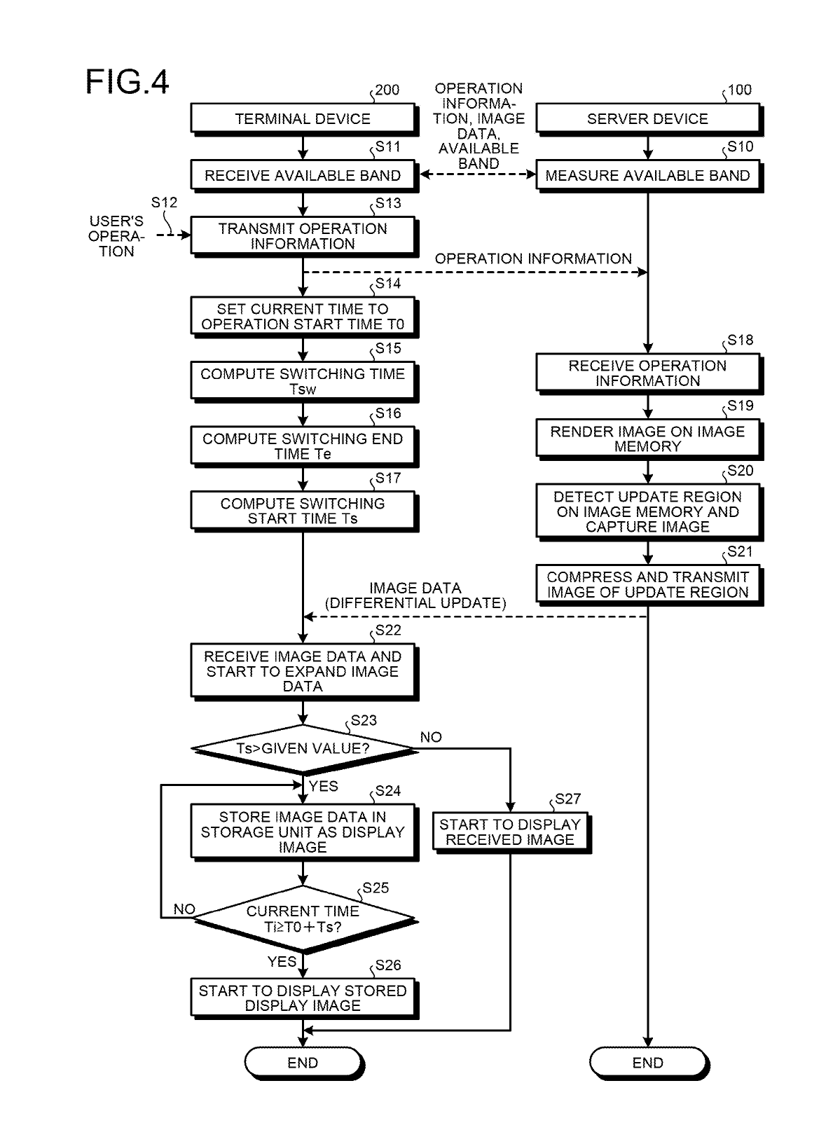

FIG. 4 is a sequence diagram illustrating an example of the operation of the thin client system according to the embodiment. For example, concerning image data having been just transmitted to the terminal device 200, the measurement unit 106 of the server device 100 acquires the amount of the image data from the communication unit 102. Furthermore, for example, concerning image data having been just transmitted to the terminal device 200, the measurement unit 106 acquires the transfer time from the terminal device 200 via the communication unit 102. The measurement unit 106 measures the available band, for example, based on the amount of the image data having been just transmitted, the transmission time which the communication unit 102 transmitted, and the transfer time acquired from the terminal device 200. Note that for example, to measure the available band, it is also acceptable to measure the amount of communication data between the communication unit 102 of the server device 100 and the communication unit 201 of the terminal device 200 every one second. The measurement unit 106 outputs the resulting available band to the communication unit 102. The communication unit 102 transmits the available band to the terminal device 200 (Step S10). Upon reception of the available band, the communication unit 201 of the terminal device 200 outputs the available band to the control unit 205 (Step S11).

For example, when the user's operation is entered to display the next slide 22 during a presentation, the input unit 202 of the terminal device 200 outputs the operation information to the control unit 205 (Step S12). When having received the operation information from the input unit 202, the control unit 205 outputs the operation information to the communication unit 201 (Step S13), and sets the current time to the operation start time T0 and then outputs the operation information to the display control unit 207 (Step S14).

When the available band is entered, the control unit 205 outputs the received available band to the computation unit 206. Upon reception of the available band, the computation unit 206 computes the switching time Tsw, the switching end time Te, and the switching start time Ts. Note that if no change is made to the setting, the switching time Tsw to be employed may take on a predetermined value. The computation unit 206 computes the switching time Tsw of the display image based on the screen size of the display unit 203 entered from the display control unit 207 and a predetermined switching speed of the display image (Step S15).

Furthermore, the computation unit 206 computes the amount of one screenful of display image data based on the screen size of the display unit 203 and the average compression ratio. Note that if no change is made to the setting, the amount of one screenful of display image data to be employed may also take on a predetermined value as in the case of the switching time Tsw. The computation unit 206 computes the switching end time Te, in which the switching of display image is ended, based on the computed amount of one screenful of display image data and the received available band (Step S16). Furthermore, the computation unit 206 computes the switching start time Ts based on the switching time Tsw and the switching end time Te (Step S17).

The communication unit 102 of the server device 100 receives the operation information from the terminal device 200 for output to the control unit 101 (Step S18). Upon reception of the operation information, the control unit 101 executes the server-side remote screen control app and various types of applications depending on the operation information. The server-side remote screen control app controls the rendering unit 103 to allow the image of an application executed on the control unit 101 to be rendered and stored on the image memory 104 (Step S19).

The server-side remote screen control app controls the detection unit 105 to detect an update of the image rendered on the image memory 104, and captures, if any, an update and creates the differential image data (Step S20). The detection unit 105 compresses the created differential image data for output to the communication unit 102. The communication unit 102 transmits the received image data to the terminal device 200 (Step S21).

Upon reception of the image data from the server device 100, the communication unit 201 of the terminal device 200 outputs the image data to the control unit 205. Upon reception of the image data from the communication unit 201, the control unit 205 starts to expand the compressed image data (Step S22).

The computation unit 206 determines whether the computed switching start time Ts exceeds a predetermined value (Step S23). If the switching start time Ts exceeds the predetermined value (Step S23: YES), the computation unit 206 does not directly output display information to the control unit 205. For example, the control unit 205 stores the expanded image data in the storage unit 204 as the display image after a predetermined time has elapsed (Step S24).

The display control unit 207 receives the operation start time T0 from the control unit 205 and receives the switching start time Ts and the switching speed from the computation unit 206. The display control unit 207 adds the switching start time Ts to the operation start time T0 to compute the switching start time Tas. The display control unit 207 determines whether the current time Ti is after the switching start time Tas (T0+Ts) (Step S25). When the current time Ti is not after the switching start time Tas (Step S25: NO), the process is returned to Step S24 and the display control unit 207 subsequently receives image data. If the current time Ti is after the switching start time Tas (Step S25: YES), the display control unit 207 reads the temporarily saved image data from the storage unit 204 and starts to display the image data on the display unit 203 at a predetermined switching speed (Step S26).

If the switching start time Ts is equal to or less than a predetermined value (Step S23: NO), the computation unit 206 directly outputs display information to the control unit 205. Upon direct reception of the display information, the control unit 205 outputs the image data entered from the communication unit 201 to the display control unit 207. The display control unit 207 displays the entered image data on the display unit 203 at the switching speed. That is, the display control unit 207 starts to display the received image on the display unit 203 at the predetermined switching speed (Step S27). Note that the thin client system 1 repeats the series of the processes of FIG. 4, thereby allowing the user to control an application operating on the server device 100 via the terminal device 200. As described above, the terminal device 200 temporarily saves the image data, which has started to be received, in the storage unit, and starts the switching display of the temporarily saved image so that the reception is completed at the same time as the switching display is ended. This allows smooth screen switching without an increase in the amount of image data to be transferred.

As described above, the terminal device 200 receives a screen image from the server device 100 which is connected thereto via a network. The terminal device 200 stores the received screen image in the storage unit 204 and then displays the screen image stored in the storage unit 204 on the display unit 203. The terminal device 200 computes the switching end time, in which the switching of the screen image is ended, based on the amount of one screenful of screen image determined from the screen size of the display unit 203 and the available band for communications with the server device 100. The terminal device 200 computes the switching start time, in which the switching of the screen image is started, based on the switching time of a screen image obtained from the screen size and the switching speed of the screen image, and the switching end time. The terminal device 200 reads the screen image from the storage unit 204 and displays the resulting image at the switching speed on the display unit 203 after the switching start time has elapsed from the reception of a user's switching operation. As a result, the screen switching can be smoothly performed. It is also possible to make a screen transition to the next page (slide) without inducing stress on the user who is watching the presentation.

Furthermore, when the switching start time is equal to or less than a predetermined value, the terminal device 200 displays a screen image received by the communication unit 201 on the display unit 203 at the switching speed in place of the screen image. As a result, when the data transfer speed is approximately equal to the display speed for switching display, the image can be displayed without buffering, so that the processing of the terminal device 200 can be alleviated.

Furthermore, the terminal device 200 also receives the available band measured by the server device 100 and computes the switching end time based on the received available band. As a result, the processing related to the measurement of the available band can be alleviated.

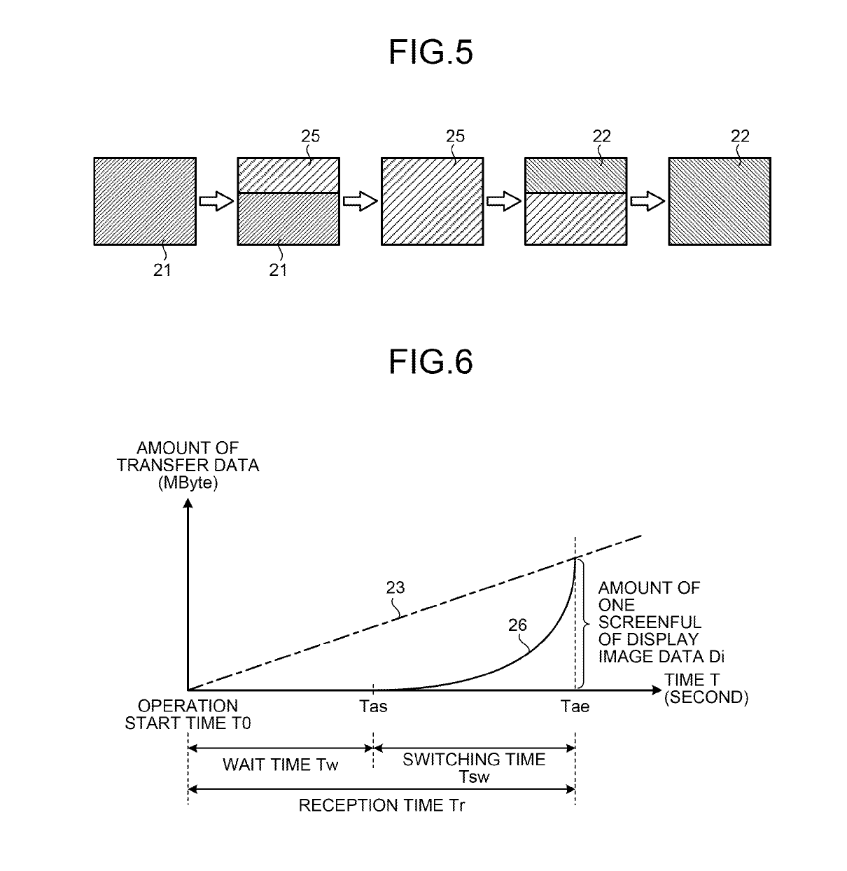

Furthermore, as illustrated in FIG. 2, in the aforementioned embodiment, the current slide 21 was switched to the next slide 22 by scroll display; however, the invention is not limited thereto. For example, the terminal device 200 can display an alternative image, which is pre-stored in the storage unit 204, between the current slide 21 and the next slide 22. FIG. 5 is an explanatory view illustrating another example of the switching of display images. As illustrated in FIG. 5, for example, when the switching start time Ts is greater than a predetermined value, the display control unit 207 of the terminal device 200 first displays an alternative image 25 pre-stored in the storage unit 204. The display control unit 207 reads the image data of the alternative image 25 from the storage unit 204 and displays the image data on the display unit 203 at the predetermined switching speed. After having displayed the alternative image 25 on the display unit 203, the display control unit 207 reads the image data of the next slide 22, which has been received and temporarily saved, for display at the predetermined switching speed on the display unit 203. Note that the alternative image to be employed may be, for example, an enterprise logo.

As described above, the terminal device 200 also stores, in the storage unit 204, an alternative image to be temporarily displayed on the display unit 203 in place of a screen image. After having read an alternative image from the storage unit 204 for display at the switching speed on the display unit 203, the terminal device 200 reads a screen image from the storage unit 204 for display at the switching speed on the display unit 203. As a result, in the case of a long reception time, it is possible to prevent the screens of a presentation from being stopped.

Furthermore, in the aforementioned embodiment, as illustrated by the graph 24 of FIG. 3, the scroll speed Vs that is the switching speed was assumed to be constant; however, the invention is not limited thereto. For example, the terminal device 200 can set the switching speed by using a function that accelerates the scroll display halfway therethrough. FIG. 6 is an explanatory view illustrating another example of the relation between the reception time and the switching time. For example, as illustrated by a graph 26 of FIG. 6, as the switching speed, the scroll speed can be a function of time as Vs(t)=αt². Note that a is an arbitrary predetermined value. Furthermore, the function of time, Vs(t), is not limited to the aforementioned one, but may also be any function as long as the function provides performance effects. For example, it is also acceptable to employ a function which allows the scroll speed to be decelerated.

In this manner, the terminal device 200 computes the switching time using, as the switching speed, a switching speed computed based on a predetermined function, and displays a screen image on the display unit 203 at the switching speed computed based on the predetermined function. As a result, the change in the screen switching speed provides high performance effects and can smoothly perform screen switching.

Furthermore, in the aforementioned embodiment, the measurement of the available band was performed by the server device 100; however, the invention is not limited thereto. For example, the terminal device 200 may also measure the available band by the communication unit 201. In this case, it is possible to alleviate the load of a network between the terminal device 200 and the server device 100 by the amount of communications on the available band.

Furthermore, in the aforementioned embodiment, an example was described in which illustrated as the screen switching display was the scroll display for overwriting the current screen with the next screen; however, the invention is not limited thereto. The terminal device 200 can also employ, as the screen switching display, the “cutting” in which the screen is instantaneously switched, or the “fading” in which the current screen is gradually faded and the next screen gradually appears, for example. Furthermore, the terminal device 200 may also employ, as the screen switching display, the “pushing” in which the next screen is displayed so as to push out the current screen, or the “wiping” in which the next screen is displayed in a manner such that the screen is wiped from the left or the right, for example.

Furthermore, each of the component members at each unit illustrated has not to be always constructed physically as illustrated. That is, specific distributed or integrated forms of each unit are not limited to those illustrated, and all or part thereof can be configured by distributing or integrating functionally or physically in an arbitrary unit depending on various types of load or service conditions. For example, the computation unit 206 may also be constructed by two units: a functional unit that computes the switching time Tsw of a display image and the amount of display image data Di and a functional unit that computes the switching end time Te and the switching start time Ts.

Furthermore, all or any part of various types of processing functions to be performed on each device may also be executed on a Central Processing Unit (CPU) (or microcomputers such as the Micro Processing Unit (MPU) or a Micro Controller Unit (MCU)). Furthermore, needless to say, all or any part of various types of processing functions may also be executed on a program to be analyzed and executed by a CPU (or a microcomputer such as the MPU or MCU), or on hardware wired logics.

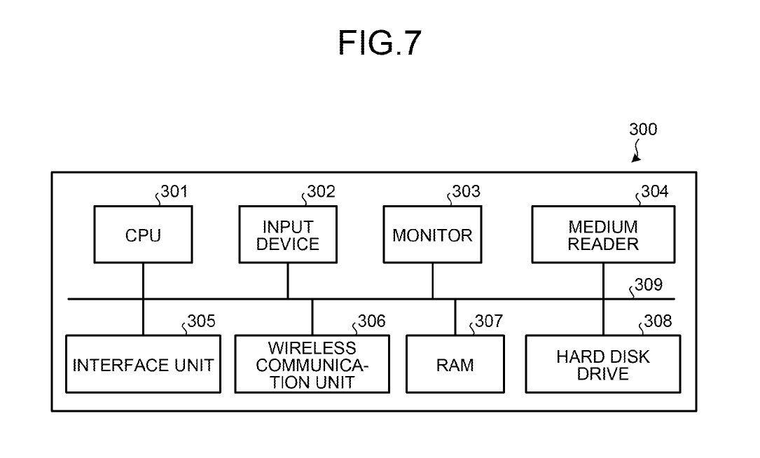

The various types of processing described in the aforementioned embodiment can be implemented by a computer executing a program prepared in advance. In this context, hereinafter, a description will be made to an example of a computer for executing a program which has the same functions as those of the aforementioned embodiment. FIG. 7 is an explanatory view illustrating an example of a computer for executing a display program.

As illustrated in FIG. 7, a computer 300 includes a CPU 301 for executing various types of computations, an input device 302 for receiving input data from the user, and a monitor 303. The computer 300 also includes a medium reader 304 for reading programs or the like on a storage medium, an interface unit 305 for connecting to another device, and a wireless communication unit 306 for connecting by radio to another device. The computer 300 further includes a RAM 307 for temporarily storing various types of information and a hard disk drive 308. Furthermore, each of the devices 301 to 308 is connected to a bus 309.

The hard disk drive 308 stores information processing programs which each have the same function as that of each of the processing units, i.e., the control unit 205, the computation unit 206, and the display control unit 207, which are illustrated in FIG. 1. The hard disk drive 308 also stores various types of data for implementing the information processing programs. The interface unit 305 and the wireless communication unit 306 include the same function as that of the communication unit 201 illustrated in FIG. 1. Furthermore, the input device 302 corresponds to the input unit 202, the monitor 303 to the display unit 203, and the RAM 307 to the storage unit 204.

The CPU 301 performs various types of processing by reading each program stored in the hard disk drive 308 and developing and executing the programs on the RAM 307. Furthermore, these programs are capable of allowing the computer 300 to function as the control unit 205, the computation unit 206, and the display control unit 207, which are illustrated in FIG. 1.

Note that the aforementioned information processing programs do not necessarily have to be stored in the hard disk drive 308. For example, the computer 300 may also read and execute a program which is stored in a storage medium that can be read by the computer 300. For example, those storage media that can be read by the computer 300 correspond to portable recording media such as CD-ROMs, DVD disks, and USB (Universal Serial Bus) memory devices, semiconductor memory devices such as flash memory devices, or hard disk drives. On the other hand, these information processing programs may be stored on a device connected to the public line, the Internet, or a Local Area Network (LAN), so that the computer 300 reads these information processing programs therefrom and executes them.

Screen switching can be smoothly performed.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A terminal device comprising:
a memory; and
a processor coupled to the memory, wherein the processor executes a process including:
receiving a screen image from a server device connected via a network;
storing the screen image received;
displaying the screen image stored in a storage;
first computing a switching end time, in which switching of the screen image is ended, based on an amount of one screenful of screen image data that is determined from a screen size of a display and an available band for communications with the server device;
second computing a switching start time, in which switching of the screen image is started, based on a switching time of the screen image obtained from the screen size and a switching speed of the screen image, and the switching end time; and
reading the screen image from the storage and displaying the screen image on the display at the switching speed after the switching start time has elapsed from reception of a user's switching operation.

2. The terminal device according to claim 1, wherein when the switching start time is equal to or less than a predetermined value, the displaying includes displaying a screen image at the switching speed on the display in place of the screen image, the screen image having been received at the receiving.

3. The terminal device according to claim 1, wherein
the receiving further includes receiving the available band measured by the server device and
the first computing includes employing an available band received at the receiving as the available band so as to compute the switching end time.

4. The terminal device according to claim 1, wherein
the storing further includes storing an alternative image to be temporarily displayed on the display in place of the screen image and
the reading includes reading the alternative image from the storage to display the alternative image at the switching speed on the display, and thereafter reading the screen image from the storage to display the screen image at the switching speed on the display.

5. The terminal device according to claim 1, wherein
the first computing includes employing, a switching speed computed based on a predetermined function as the switching speed to compute the switching time and
the displaying includes displaying the screen image on the display at a switching speed computed based on the predetermined function.

6. A thin client system comprising a server device and a terminal device, wherein:
the server device includes:
a memory; and
a processor coupled to the memory, wherein the processor executes a process including:
storing a display image to be displayed on the terminal device connected via a network;
rendering a software processed result in an image memory;
detecting an update region which has been updated between frames of an image rendered in the image memory;
measuring an available band for communications with the terminal device; and
transmitting a screen image, which is an image in the update region, and the available band to the terminal device; and
the terminal device includes:
a memory; and
a processor coupled to the memory, wherein the processor executes a process including:
receiving the screen image and the available band;
storing the screen image received at the receiving;
displaying the screen image stored in a storage;
first computing a switching end time, in which switching of the screen image is ended, based on an amount of one screenful of screen image data that is determined from a screen size of a display and an available band for communications with the server device;
second computing a switching start time, in which switching of the screen image is started, based on a switching time of the screen image obtained from the screen size and a switching speed of the screen image, and the switching end time; and
reading the screen image from the storage and displaying the screen image at the switching speed on the display after the switching start time has elapsed from reception of a user's switching operation.

7. A display method to be executed by a terminal device, the display method comprising:
receiving a screen image from a server device connected via a network, using a processor;
storing the received screen image in a storage;
displaying the screen image stored in the storage on a display, using the processor;
first computing a switching end time, in which switching of the screen image is ended, based on an amount of one screenful of screen image data that is determined from a screen size of the display and an available band for communications with the server device, using the processor;
second computing a switching start time, in which switching of the screen image is started, based on a switching time of the screen image obtained from the screen size and a switching speed of the screen image, and the switching end time, using the processor; and
reading the screen image from the storage and displaying the screen image at the switching speed on the display after the switching start time has elapsed from reception of a user's switching operation, using the processor.

8. A non-transitory computer-readable recording medium having stored therein a program that causes a computer to execute a display process comprising:
receiving a screen image from a server device connected via a network;
storing the received screen image in a storage;
displaying the screen image stored in the storage on a display;
first computing a switching end time, in which switching of the screen image is ended, based on an amount of one screenful of screen image data that is determined from a screen size of the display and an available band for communications with the server device;
second computing a switching start time, in which switching of the screen image is started, based on a switching time of the screen image obtained from the screen size and a switching speed of the screen image, and the switching end time; and
reading the screen image from the storage and displaying the screen image at the switching speed on the display after the switching start time has elapsed from reception of a user's switching operation.
